(19) United States
(12) Patent Application Publication
(10) Pub. No.: US 2020/0076987 A1
(43) Pub. Date: Mar. 5, 2020

(54) IMAGE PROCESSING APPARATUS, CONTROL METHOD THEREOF, AND STORAGE MEDIUM

(71) Applicant: CANON KABUSHIKI KAISHA, Tokyo (JP)

(72) Inventor: Yukichika Ichihashi, Kashiwa-shi (JP)

(21) Appl. No.: 16/534,788

(22) Filed: Aug. 7, 2019

(30) Foreign Application Priority Data
Aug. 31, 2018 (JP) 2018-163188

(51) Int. Cl. H04N 1/60; G06F 3/12

(52) U.S. Cl. CPC H04N 1/6019; H04N 1/6008; H04N 2201/0094; G06F 3/1208; G06F 3/1247; H04N 1/6066

(57) ABSTRACT

A color of an image that is printed based on a second color value obtained by converting a color value of a specific color falling outside a color gamut without using a first conversion table is closer to the specific color falling outside the color gamut than a color of an image that is printed based on a first color value obtained by converting the color value of the specific color falling outside the color gamut by using the first conversion table.

### BACKGROUND

### Field of the Disclosure

The present disclosure generally relates to image processing and, more particularly, to an image processing apparatus, a control method thereof, and a storage medium.

### Description of the Related Art

A specific color, such as a special red color called “Chinese Red” used in a Chinese official document with a red heading or a corporate color, falls outside a color gamut of a scanner included in a multifunction peripheral, and such a specific color may also fall outside a color gamut of a printer.

According to a technique discussed in Japanese Patent Application Laid-Open No. 2008-211285, when image data is to be generated by reading a document using a scanner of a multifunction peripheral, a color as close as possible to a color of the document is reproduced by generating image data having a color gamut compressed to a color gamut of an output device such as a printer or a display device.

### SUMMARY

When a document using a specific color falling outside a color gamut of a scanner of a multifunction peripheral (MFP) is to be copied, there is a problem in that the specific color cannot be expressed because the color gamut of the image data generated by reading the document using the scanner does not fall within the color gamut of the scanner. Thus, if an image is printed on a sheet based on that image data, a color of the output image will be different from the specific color.

Accordingly, when the document using the specific color falling outside the color gamut of the scanner of the MFP is to be copied, an image having a color close to the color of the read document cannot be output.

The present disclosure is directed to a technique that enables a scanner of an MFP to output a color as close as possible to a color of a document when the document using a specific color falling outside the scanner is to be copied.

Further, the present disclosure is directed to a technique that enables a printer to output a color as close as possible to a color of a document based on a portable document format (PDF) file in a case where the PDF file is to be generated by scanning a document using a specific color falling outside the color gamut of the scanner of the MFP.

According to an aspect of the present disclosure, an image processing apparatus includes a reading unit configured to read an image of a document to generate image data, a conversion unit configured to convert a color value of a color, from among colors of the image data, falling within a color gamut of the reading unit into a first color value by using a first conversion table, and to convert a color value of a specific color, from among the colors of the image data, falling outside the color gamut of the reading unit into a second color value without using the first conversion table, and a printing unit configured to print an image on a sheet based on the color value converted by the conversion unit, wherein a color of an image that is printed based on the second color value obtained by converting the color value of the specific color falling outside the color gamut without using the first conversion table is closer to the specific color falling outside the color gamut than a color of an image that is printed based on the first color value obtained by converting the color value of the specific color falling outside the color gamut by using the first conversion table.

According to another aspect of the present disclosure, an image processing apparatus includes a reading unit configured to read an image of a document to generate image data, a generation unit configured to generate a PDF file based on the image data generated by the reading unit, and an addition unit configured to add a profile to the PDF file generated by the generation unit, wherein, in a case where a specific color falling outside a color gamut of the reading unit is included in the image read by the reading unit, the addition unit adds a profile for outputting the specific color as a color closer to the specific color than a color output in a case where the profile is not added to the PDF file generated by the generation unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a system using a multifunction peripheral (MFP).

FIG. 2 is a block diagram illustrating an example of a hardware configuration of the MFP.

FIG. 3 is a block diagram illustrating an example of a software configuration of the MFP.

FIG. 4 is a flowchart illustrating an example of copying processing executed by the MFP.

FIG. 5 is a flowchart illustrating an example of processing to be executed when the MFP prints an image on a sheet based on image data on which color space conversion is executed.

FIG. 6 is a flowchart illustrating an example of processing to be executed when the MFP determines whether a specific color is included in generated image data.

FIG. 7 is a flowchart illustrating an example of processing to be executed when the MFP determines whether a specific color is included in a selected area.

FIGS. 8A, 8B, and 8C are diagrams illustrating examples of red-green-blue (RGB) histograms.

FIGS. 9A, 9B, and 9C are diagrams illustrating examples of a lattice and an ab plane for converting input RGB values into Lab values defined by the International Commission on Illumination (CIE)(i.e., “CIELab values”).

FIG. 10 is a diagram illustrating an example of an image expressed by image data segmented into areas.

FIG. 11 is a diagram illustrating an example of a setting screen.

FIG. 12 is a flowchart illustrating an example of processing of setting RGB values of a specific color to the MFP.

FIG. 13 is a flowchart illustrating an example of processing for scanning a document including a specific color and generating a portable document format (PDF) file.

FIG. 14 is a flowchart illustrating an example of processing for printing a PDF file to which an international color consortium (ICC) profile indicating a specific color is added.

### DESCRIPTION OF THE EMBODIMENTS

Hereinafter, various exemplary embodiments, features, and aspects of the present disclosure will be described with reference to the appended drawings. Configurations described in the following exemplary embodiments are merely examples, and the present disclosure is not limited to the configurations illustrated in the drawings.

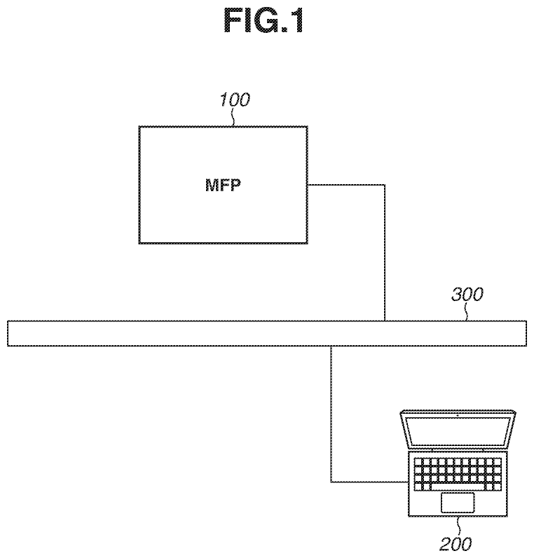

FIG. 1 is a diagram illustrating an example of a system using a multifunction peripheral (MFP) 100.

The system in FIG. 1 includes the MFP 100 as one example of an image processing apparatus, and a personal computer (PC) 200 serving as an information processing apparatus. The MFP 100 is connected with the PC 200 via a local area network (LAN) 300. In a first exemplary embodiment, the MFP 100 is connected with the PC 200 via the LAN 300. However, the configuration is not limited thereto, and the MFP 100 may also be connected with the PC 200 via the Internet. Further, a plurality of PCs may be connected with the MFP 100 via the LAN 300.

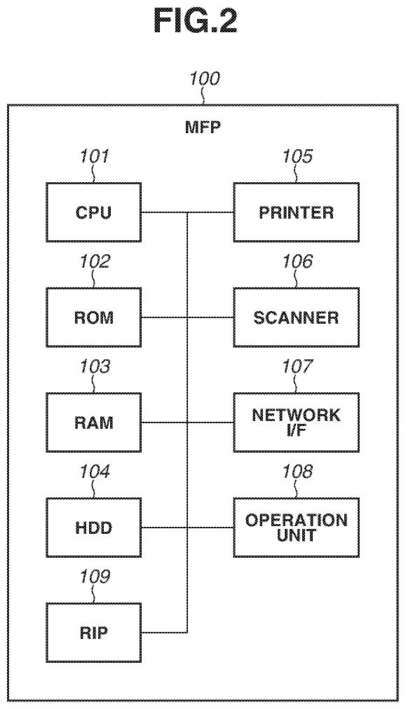

FIG. 2 is a block diagram illustrating an example of a hardware configuration of the MFP 100. The MFP 100 includes a central processing unit (CPU) 101, a read only memory (ROM) 102, a random access memory (RAM) 103, a hard disk drive (HDD) 104, a printer 105, a scanner 106, a network interface (UF) 107, and an operation unit 108. The MFP 100 further includes a raster image processor (RIP) 109.

The CPU 101, which may include one or more processors, circuitry, or a combination thereof, may control various types of hardware 104 to 108 that constitute the MFP 100 to implement various functions of the MFP 100. The CPU 101 mutually executes data communication with the various types of hardware 104 to 108 by transmitting signals thereto via a bus line.

The MFP 100 may have one or more memories including, for example, the ROM 102, the RAM 103, and the HDD 104. The ROM 102 stores a program and various data used by the CPU 101. The RAM 103 is a work memory for temporarily storing a program and data used by the CPU 101 to execute calculation. The HDD 104 stores various data and various programs. In the present exemplary embodiment, although the MFP 100 that uses an HDD as an auxiliary storage device will be described as an example, the MFP 100 may also use a non-volatile memory such as a solid state drive (SSD) as the auxiliary storage device.

The printer 105 is a unit for implementing a printing function, and executes processing for printing an image on a sheet based on image data included in a print job transmitted from the PC 200.

The scanner 106 is a unit for implementing a scanning function, and executes processing for optically reading a document and converting the read document into image data.

The CPU 101 of the MFP 100 controls an operation of the MFP 100 based on a control program stored in the MFP 100. More specifically, the CPU 101 executes an operating system (OS) for controlling the MFP 100 and a driver program for controlling a hardware interface. Application programs provided on the OS operate mutually, so that a function desired by a user is operated and controlled. The above-described OS and various programs are stored in the ROM 102 and executed by being read from the ROM 102 to the RAM 103.

The network OF 107 of the MFP 100 may be a LAN OF for wired connection, and may be connected using a universal serial bus (USB)-LAN adapter. The network OF 107 may also be a LAN OF for wireless connection. The network OF 107 of the MFP 100 is connected with the PC 200 via the LAN 300.

The operation unit 108 is a user interface that allows a user who uses the MFP 100 to use the printer 105 and the scanner 106. For example, the operation unit 108 is a touch panel for receiving an operation and an input. The operation unit 108 can also be used as a display unit for displaying information about the MFP 100. Alternatively, an operation device and a display device of the MFP 100 of the present exemplary embodiment may be connected externally.

The RIP 109 is a hardware module for executing rasterization processing for rasterizing page description language (PDL) into a raster image. In the present exemplary embodiment, the RIP 109 built in as hardware will be described as an example. However, the RIP 109 may also be stored in the ROM 102 as software.

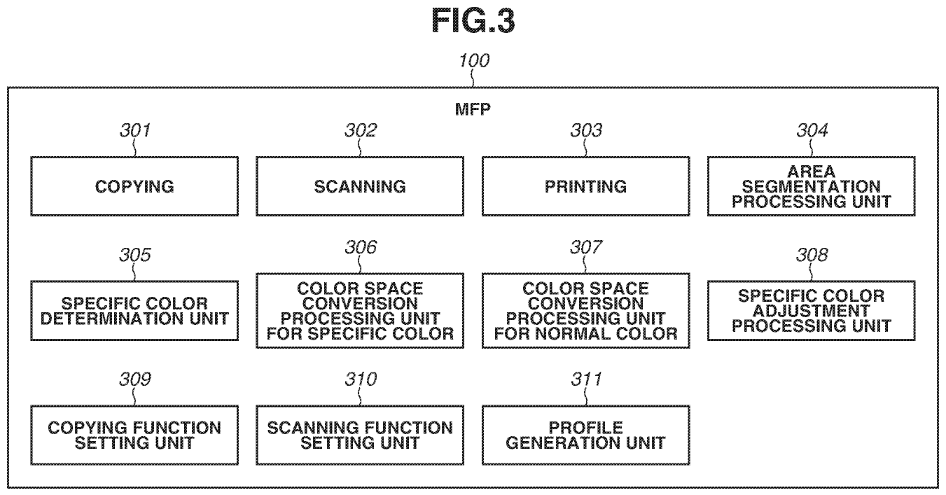

FIG. 3 is a block diagram illustrating an example of a software configuration of the MFP 100. Software modules are stored in the ROM 102, read out from the ROM 102 to the RAM 103, and executed by the CPU 101.

By executing copying 301, the CPU 101 controls the scanner 106 and the printer 105 to execute copying processing for printing an image on a sheet based on image data generated by reading a document.

By executing scanning 302, the CPU 101 controls the scanner 106 to execute scanning processing for reading a document and generating image data.

By executing printing 303, the CPU 101 controls the printer 105 and the RIP 109 to store a print job described in PDL received via the network OF 107 in the HDD 104, and executes printing based on print setting information included in the print job.

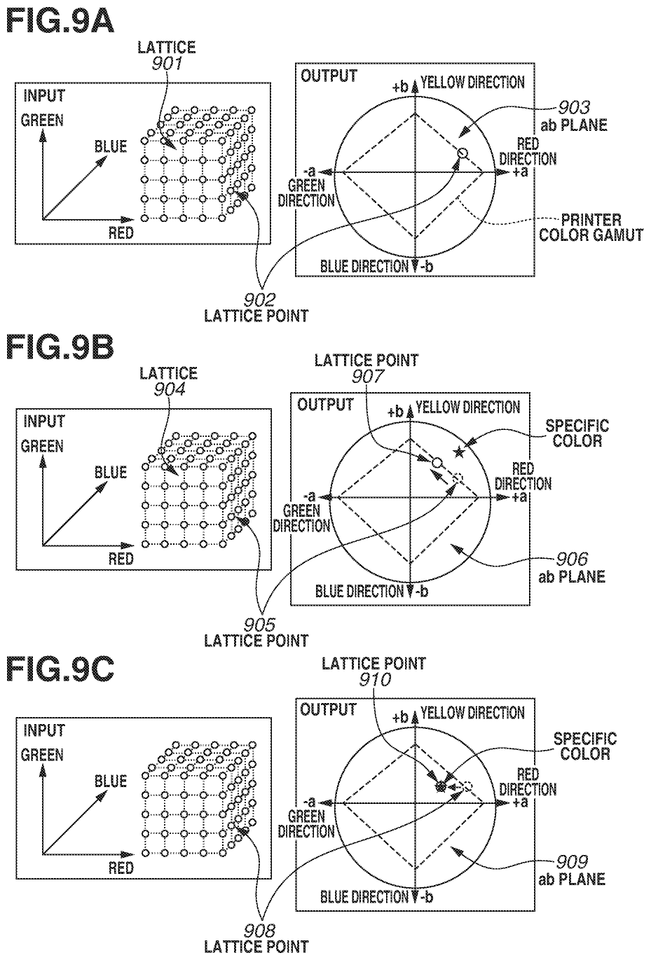

By executing an area segmentation processing unit 304, the CPU 101 executes processing for segmenting generated image data into a plurality of areas. Details of the area segmentation processing will be described with reference to FIGS. 9A, 9B, and 9C.

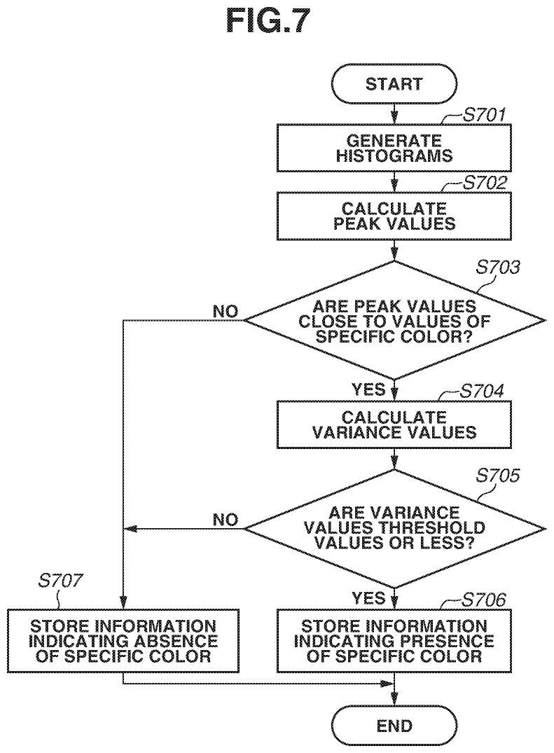

By executing a specific color determination unit 305, the CPU 101 determines whether a specific color is used in a scanned document. Details of the processing executed by the specific color determination unit 305 will be described with reference to FIG. 7.

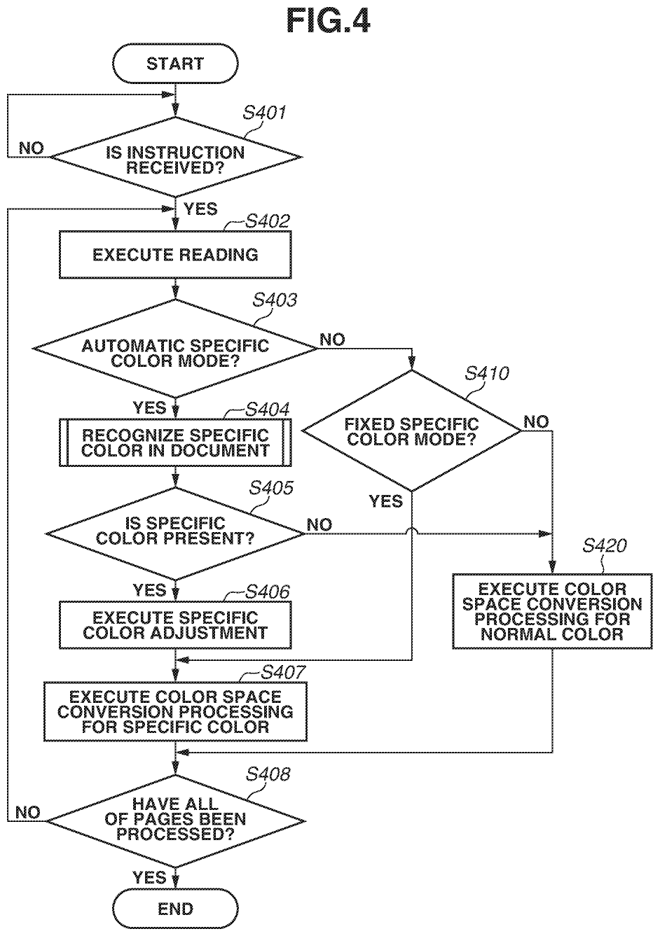

If a specific color is included in the scanned document, the CPU 101 executes a color space conversion processing unit 306 for the specific color to convert red-green-blue (RGB) values into Lab values defined by the International Commission on Illumination (CIE) (i.e., CIELab values) and cyan-magenta-yellow-black (CMYK) values. Details will be described with reference to FIG. 4.

If the specific color is not included in the scanned document, the CPU 101 executes a color space conversion processing unit 307 for a normal color to convert RGB values into CIELab values and CMYK values. Details will be described with reference to FIG. 4.

The CPU 101 executes a specific color adjustment processing unit 308 to adjust CIELab values corresponding to input RGB values in order to easily execute color space conversion processing for the specific color. Details will be described with reference to FIG. 4.

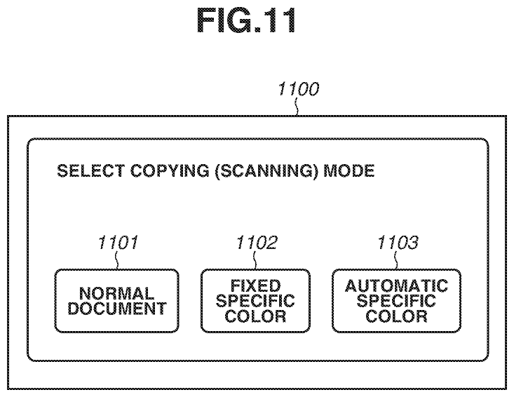

The CPU 101 receives a user operation on a setting screen 1100 in FIG. 11, and reflects a setting corresponding to the selected button by executing a copying function setting unit 309. FIG. 11 is a diagram illustrating an example of the setting screen.

If a normal document button 1101 is selected, a copying (scanning) function of the MFP 100 is set to a normal document mode. The normal document mode refers to a mode for executing color space conversion processing for the normal color on generated image data in a case where the specific color is not used in a document.

If a fixed specific color button 1102 is selected, the copying (scanning) function of the MFP 100 is set to a fixed specific color mode. The fixed specific color mode refers to a mode for executing color space conversion processing for the specific color on all of generated image data.

If an automatic specific color button 1103 is selected, the copying (scanning) function of the MFP 100 is set to an automatic specific color mode. In the automatic specific color mode, the CPU 101 determines whether the specific color is included in the generated image data. If the specific color is included, the color space conversion processing for the specific color is executed. If the specific color is not included, the color space conversion processing for the normal color is executed.

By executing a scanning function setting unit 310, the CPU 101 receives a user operation on the setting screen 1100 illustrated in FIG. 11 and reflects a setting corresponding to the selected button.

By executing a profile generation unit 311, the CPU 101 generates an international color consortium (ICC) profile, which is information for enabling a printing device to execute printing with appropriate colors.

The following problem occurs when a document using a specific color falling outside of a color gamut of a scanner and a color gamut of a printer of an MFP is to be copied by the MFP according to Japanese Patent Application Laid-Open No. 2008-211285. A color gamut of image data read and generated for copying the document is compressed into the color gamut of the printer, so that the specific color cannot be expressed thereby. Thus, if an image is printed on a sheet based on the image data, a color of the output image will be different from the specific color. Further, because the specific color also falls outside the color gamut of the scanner, the color gamut of the image data read and generated for copying the document is forcibly compressed into the color gamut of the scanner before being compressed into the color gamut of the printer. Thus, an error occurs when the color gamut of the image data is compressed into the color gamut of the printer, so that a color close to the specific color cannot be output.

To solve the above-described problem, by executing the following processing, a color as close as possible to the color of the document can be output when the document using the specific color falling outside the color gamut of the scanner of the MFP is to be copied.

FIG. 4 is a flowchart illustrating an example of copying processing executed by the MFP 100. The CPU 101 reads out a program stored in the ROM 102 to the RAM 103 and executes the program, so that processing of the flowchart in FIG. 4 is implemented.

In step S401, the CPU 101 determines whether a copying instruction is received from the user via the operation unit 108. If the CPU 101 determines that the copying instruction is received (YES in step S401), the processing proceeds to step S402. If the CPU 101 determines that the copying instruction is not received (NO in step S401), the processing returns to step S401. In step S401, the CPU 101 also receives an instruction about a copying mode in addition to the copying instruction. The instruction about the copying mode is received on a screen illustrated in FIG. 11.

In step S402, the CPU 101 reads an image on a document based on the instruction received from the user in step S401, generates image data in RGB colors, and stores the image data in the HDD 104.

In step S403, the CPU 101 determines whether a copying function is set to the automatic specific color mode. If the copying function is set to the automatic specific color mode (YES in step S403), the processing proceeds to step S404. If the copying function is not set to the automatic specific color mode (NO in step S403), the processing proceeds to step S410.

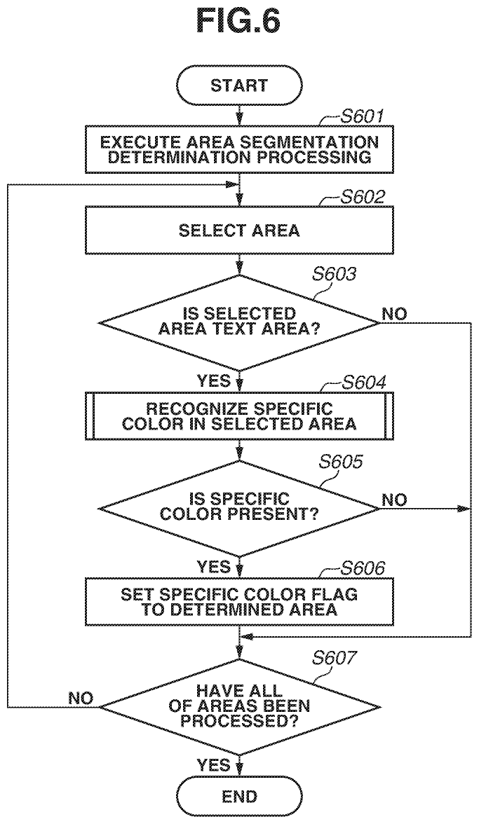

In step S404, the CPU 101 recognizes a specific color included in the generated image data. Details of the processing in step S404 will be described with reference to FIG. 6.

FIG. 6 is a flowchart illustrating an example of processing to be executed when the CPU 101 determines whether a specific color is included in the generated image data. The CPU 101 reads out a program stored in the ROM 102 to the RAM 103 and executes the program, so that processing of the flowchart in FIG. 6 is implemented. The flowchart in FIG. 6 is started when the CPU 101 determines that the copying function is set to the automatic specific color mode in step S403 of the flowchart in FIG. 4.

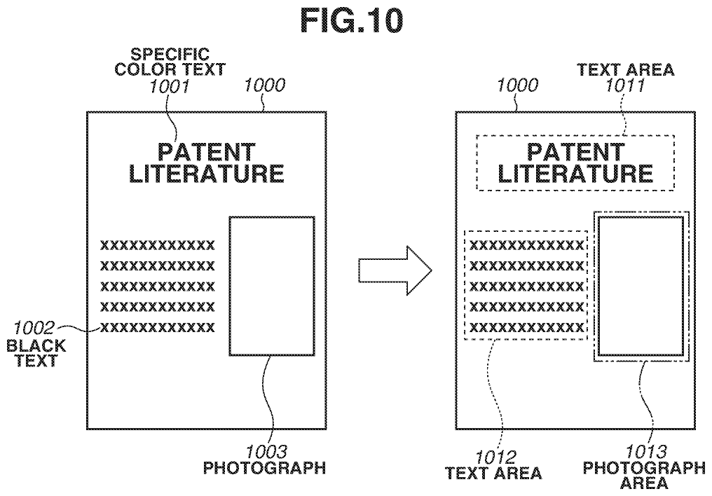

In step S601, the CPU 101 executes area segmentation determination processing on the generated image data. In the area segmentation determination processing, image data corresponding to one page is converted into image data having low resolution, and the image data is segmented into a plurality of areas by regarding a chunk of image data having a color difference between a background and an image as one area. By this processing, each of the segmented areas can be classified as a text area or a photograph area. Herein, an example of an image expressed by the image data segmented into the plurality of areas will be described with reference to FIG. 10.

FIG. 10 is a diagram illustrating the example of the image expressed by the image data segmented into areas.

An image 1000 expressed by image data generated by the MFP 100 is segmented into three areas through the area segmentation processing. After the image 1000 is segmented into three areas, the CPU 101 determines whether each of the areas is a text area or a photograph area. In the image 1000, text 1001 “PATENT LITERATURE” expressed in a specific color is determined as a text area 1011, and a sentence 1002 expressed in black letters is determined as a text area 1012. Further, a photograph 1003 is determined as a photograph area 1013.

In step S602, the CPU 101 selects one of the areas segmented in step S601. In a case where the processing in steps S602 to S607 has been executed repeatedly, the CPU 101 selects one area that has not been selected yet.

In step S603, the CPU 101 determines whether the area selected in step S602 is a text area. If the CPU 101 determines that the selected area is the text area (YES in step S603), the processing proceeds to step S604. If the selected area is not the text area, i.e., if the CPU 101 determines that the area is a non-text area (NO in step S603), the processing proceeds to step S607.

In step S604, the CPU 101 recognizes a specific color included in the area selected in step S602. Details of this processing will be described with reference to a flowchart in FIG. 7.

FIG. 7 is a flowchart illustrating an example of processing for determining whether a specific color is included in the selected area. The CPU 101 reads out a program stored in the ROM 102 to the RAM 103 and executes the program, so that processing of the flowchart in FIG. 7 is implemented. The flowchart in FIG. 7 is started when the CPU 101 determines that the selected area is the text area in step S603 of the flowchart in FIG. 6.

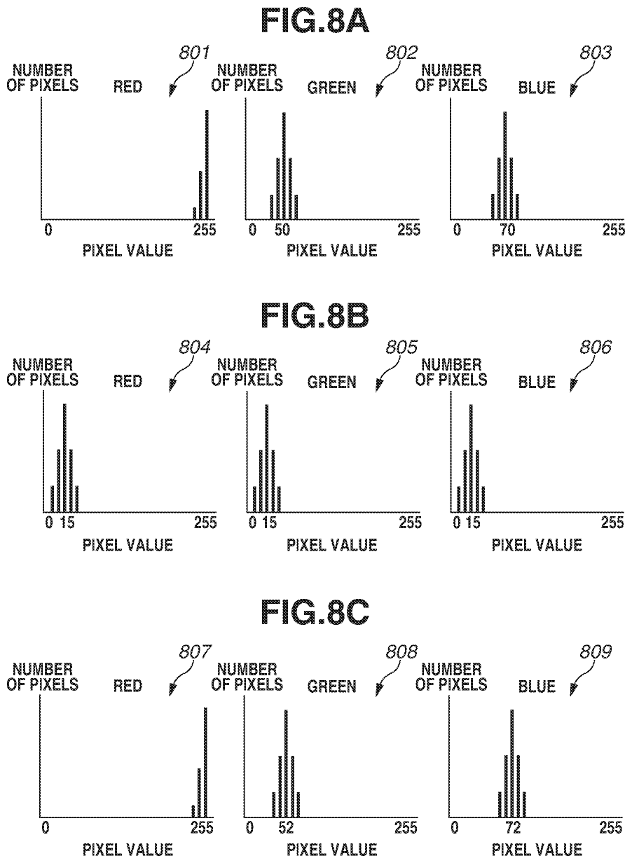

In step S701, the CPU 101 generates RGB histograms of the selected area. The RGB histogram is a graph indicating the number of pixels having a particular pixel value with respect to each of the RGB components. Examples of the RGB histograms are illustrated in FIGS. 8A, 8B, and 8C.

FIGS. 8A, 8B, and 8C are diagrams illustrating examples of the RGB histograms.

FIG. 8A is a diagram illustrating examples of RGB histograms of a specific color (i.e., Chinese Red). Histograms 801 to 803 are RGB histograms of the text area 1011 in FIG. 10, i.e., RGB histograms of the specific color (Chinese Red). A horizontal axis represents a pixel value, and a vertical axis represents the number of pixels for each pixel value (appearance frequency). Most frequent values of the histograms 801 to 803 can be expressed as “(R, G, B)=(255, 50, 70)”.

FIG. 8B is a diagram illustrating examples of RGB histograms of a black color. Histograms 804 to 806 are RGB histograms of the text area 1012, i.e., RGB histograms of the black color. Most frequent values of the histograms 804 to 806 can be expressed as “(R, G, B)=(15, 15, 15)”. The histograms are generated after removing the background color from the text. For example, in order to remove the background color from the text, mask data is created by using a binary image created through binary processing, and histograms are created for masked pixels (pixels of text) only.

In step S702, the CPU 101 calculates peak values (most frequent values) of the components of the RGB histograms generated in step S701.

In step S703, the CPU 101 determines whether the peak values (most frequent values) calculated in step S702 are close to the RGB values of the specific color. For example, the RGB values of the specific color are (R, G, B)=(255, 52, 71) acquired by the MFP 100 of the present exemplary embodiment reading text printed in Chinese Red. Alternatively, the RGB values of the specific color may be RGB values of a special color such as a corporate color. The RGB values of the specific color may be previously set at the time of factory shipment or may be set by the user operating the operation unit 108. In a case where the CPU 101 determines whether the peak values are close to the RGB values of Chinese Red, the CPU 101 determines whether the most frequent value of the R-component is 255, whether the most frequent value of the G-component is a value within a range of ±5% from 52, and whether the most frequent value of the B-component is a value within a range of ±5% from 71. In other words, the CPU 101 determines that the peak values are close to the RGB values of the specific color (Chinese Red) if the most frequent value of the R-component is 255, the most frequent value of the G-component is a value within the range of ±5% from 52, and the most frequent value of the B-component is a value within the range of ±5% from 71. Herein, the most frequent value of the R-component does not have an allowable error because the pixel value of the R-component in the histogram acquired by scanning Chinese Red overflow as illustrated in the histogram 801 in FIG. 8A.

If the CPU 101 determines that the peak values are close to the RGB values of the specific color (YES in step S703), the processing proceeds to step S704. If the CPU 101 determines that the peak values are not close to the RGB values (NO in step S703), the processing proceeds to step S707.

In step S704, the CPU 101 calculates variance values of the RGB histograms generated in step S701.

In step S705, the CPU 101 determines whether the variance values calculated in step S704 are threshold values or less. By determining whether the variance values of the histograms are the threshold values or less, the CPU 101 can determine whether text with a decorative effect such as gradation of color, which is not used in the official document with a red heading printed in Chinese Red, is included in the text area. In a case where the above determination is executed on text such as a corporate name using a corporate color, the processing in step S705 does not have to be executed because the gradation of color can be used therein. If the CPU 101 determines that the variance values are the threshold values or less (YES in step S705), the processing proceeds to step S706. If the CPU 101 determines that the variance values are greater than the threshold values (NO in step S705), the processing proceeds to step S707. On example of the threshold values of the variance values is (R, G, B)=(3, 15, 15).

If there is another condition under which the specific color appears, the condition may also be added. For example, if the specific color only appears on a first page, a condition indicating that the specific color appears on the first page may be added. In addition, if an appearance position of the specific color is limited, e.g., if the specific color appears in lower-right of a document, determination may be executed based on a position where the specific color is detected.

In step S706, the CPU 101 stores information indicating presence of the specific color in the RAM 103 and ends the processing.

In step S707, the CPU 101 stores information indicating absence of the specific color in the RAM 103 and ends the processing.

Referring back to the flowchart in FIG. 6, in step S605, the CPU 101 determines whether information indicating the presence or absence of the specific color is stored in the RAM 103 in step S706 or S707. If the CPU 101 determines that the information indicating the presence of the specific color is stored in the RAM 103 (YES in step S605), the processing proceeds to step S606. If the CPU 101 determines that the information indicating the presence of the specific color is not stored in the RAM 103 (NO in step S605), the processing proceeds to step S607.

In step S606, the CPU 101 stores, in the RAM 103, a list of coordinates of the area in which the specific color is determined to be present, a page number of the document where the specific color is present, and a flag indicating the presence of the specific color.

In step S607, the CPU 101 determines whether all of the areas have been selected and whether determination on the presence or absence of the specific color has been executed. If the CPU 101 determines that the determination has been executed on all of the areas (YES in step S607), the processing is ended. If the CPU 101 determines that the determination has not been executed on all of the areas (NO in step S607), the processing returns to step S602.

Referring back to the flowchart in FIG. 4, in step S405, the CPU 101 refers to the list stored in the RAM 103 in step S404 and determines whether the flag indicating that the specific color is present is stored for at least one area. If the CPU 101 determines that the flag indicating the presence of the specific color is stored (YES in step S405), the processing proceeds to step S406. If the CPU 101 determines that the flag indicating the presence of the specific color is not stored (NO in step S405), the processing proceeds to step S420.

In step S406, the CPU 101 refers to the list stored in the RAM 103 and executes specific color adjustment processing on the area in which the specific color is determined to be present. The specific color adjustment processing will be described in detail with reference to FIGS. 9A, 9B, and 9C.

FIGS. 9A, 9B, and 9C are diagrams illustrating examples of a lattice and an ab plane for converting the input RGB values into CIELab values.

A lattice 901 in FIG. 9A illustrates a three-dimensional look-up table (LUT), which is a conversion table the MFP 100 stores in the ROM 102. Each of the lattice points corresponds to each element of the LUT. The three-dimensional LUT stored in the ROM 102 is a table used by the MFP 100 to convert RGB values of an image read by the scanner 106 into CIELab values. In order to store the elements (lattice points) corresponding to all of the RGB values, a large storage area may be desirable because a three-dimensional LUT of 256×256×256 having the elements (lattice points) corresponding to 0 to 255 input values may be desirable on each of axes. Thus, the lattice points are arranged at regular distances as in the lattice 901 of FIG. 9A. Five lattice points are arranged on each axis in FIG. 9A. Alternatively, eight lattice points may be arranged on each axis. For example, in the LUT of 8×8×8, Lab values corresponding to (R, G, B)=(0, 0, 0) are associated with an origin, and Lab values corresponding to (R, G, B)=(8, 0, 0) are associated with a lattice point just next to the origin on the right side thereof. Thus, in a case where RGB values corresponding to a position between the lattice points are input, the RGB values may be approximated to the values of adjacent lattice points by executing interpolation calculation using the values of the adjacent lattice points and a weighting coefficient. The processing for converting the RGB values into the CIELab values is executed for each pixel. In addition, the LUT may be stored in the HDD 104 instead of the ROM 102.

In FIG. 9A, CIELab values corresponding to a lattice point 902 representing input RGB values are set within a color gamut that can be output by the printer 105. The above is expressed by the lattice point 902 in the ab plane 903. In the present exemplary embodiment, the ab plane will be used instead of the Lab color space for purpose of description.

An ab plane 906 in FIG. 9B illustrates color space conversion executed when the RGB values (R, G, B)=(255, 52, 71) of Chinese Red, which is the specific color, is input. The specific color such as Chinese Red falls outside the color gamut of the scanner 106 and falls outside the color gamut of the printer 105. Thus, if the CIELab values corresponding to the input RGB values are output directly, there is a possibility that a color such as a color represented by a lattice point 905, which is considerably different from the specific color, is output. Thus, the CIELab values may be set so that the output (printed) color becomes a color as close as possible to or substantially the same as the color used in the document, e.g. the output color may fall within a predetermined range of the color used in the document. For example, in normal cases, CIELab values associated with the lattice point 905 are output when the RGB values of Chinese Red are input. However, in order to output CIELab values of a color as close as possible to Chinese Red, CIELab values associated with a lattice point 907 are output when the RGB values of Chinese Red are input. Further, the CIELab values are converted into CMYK values that can be output by the printer 105. The color space conversion processing for the specific color has been described as the above.

In a case where the lattice 904 has eight lattice points on each axis (LUT of 8×8×8), RGB values corresponding to the lattice point 905 having the output values (CIELab values) of the lattice point 907 are (R, G, B)=(255, 56, 72). If most frequent values of the RGB values are (R, G, B)=(255, 52, 71) when Chinese Red is scanned, values of G and B are values corresponding to a position between the lattice points. Thus, in the normal cases, the values have to be approximated to the values corresponding to adjacent lattice points through the interpolation calculation. However, in a case where the most frequent values are (R, G, B)=(255, 52, 71), the values are directly converted into the RGB values corresponding to the lattice point 905 because a target output color has been determined as Chinese Red. A formula “Output Value=Specific Color÷Most Frequent Value×Input Value” is used when the above-described conversion is executed. In the above formula, “Specific Color” refers to RGB values corresponding to a lattice point for outputting the specific color and is, for example, the RGB values (R, G, B)=(255, 56, 72) corresponding to the lattice point 905. Further, “most frequent value” refers to most frequent values of RGB values of the created histograms, “Input Value” refers to RGB values input by scanning. The specific color adjustment processing has been described as the above. The specific color adjustment processing is executed on each of the foreground pixels (corresponding to text) within the area in which the specific color is determined to be used. By executing the specific color adjustment processing, the color space conversion processing for the specific color can be executed on a pixel having the most frequent values of input RGB values without employing the interpolation calculation, which may result in a large error.

For example, if the specific color adjustment is executed on the input values illustrated in the histograms 801 to 803 in FIG. 8A, the values are adjusted to values illustrated in the histograms 807 to 809 in FIG. 8C.

The ab plane 909 in FIG. 9C illustrates an example in which a specific color falls within the color gamut of the printer 105. When the input RGB values represent the specific color, instead of outputting CIELab values associated with a lattice point 908 corresponding to the input RGB values, the input RGB values are converted into CIELab values associated with a lattice point 910 for outputting the specific color, so that the specific color is output with certainty.

In step S407, the CPU 101 executes the color space conversion processing for the specific color and stores the converted image data in the HDD 104. In the present exemplary embodiment, the color space conversion processing for the specific color is executed on a whole page where the specific color is present. However, the color space conversion processing for the specific color may also be executed on an area where the presence of the specific color is determined, and the color space conversion processing for the normal color may be executed on another area.

In step S408, the CPU 101 determines whether the color space conversion processing has been executed on all of the scanned pages. If the CPU 101 determines that all of the scanned pages have been processed (YES in step S408), the processing is ended. If the CPU 101 determines that not all of the scanned pages have been processed (NO in step S408), the processing returns to step S403. The processing in steps S403 to S407 may be executed simultaneously with the processing of reading a document image and generating image data executed by the scanner 106, which is a reading unit.

Herein, the processing to be executed when the CPU 101 determines that a mode is not set to the automatic specific color mode in step S403 will be described.

In step S410, the CPU 101 determines whether the copying function is set to the fixed specific color mode. If the CPU 101 determines that the copying function is set to the fixed specific color mode (YES in step S410), the processing proceeds to step S407. If the CPU 101 determines that the copying function is not set to the fixed specific color mode (NO in step S410), the processing proceeds to step S420.

In step S420, the CPU 101 executes the color space conversion processing for the normal color. In the color space conversion processing for the normal color, by using the LUT such as the lattice 901 in FIG. 9A, CIELab values set in advance for RGB values corresponding to each of the lattice points are output in response to input of the RGB values, and the output CIELab values are converted into CMYK values. Further, in the color space conversion processing for the normal color, when RGB values corresponding to a position between lattice points are input, the input values are approximated to values of adjacent lattice points by executing the interpolation calculation.

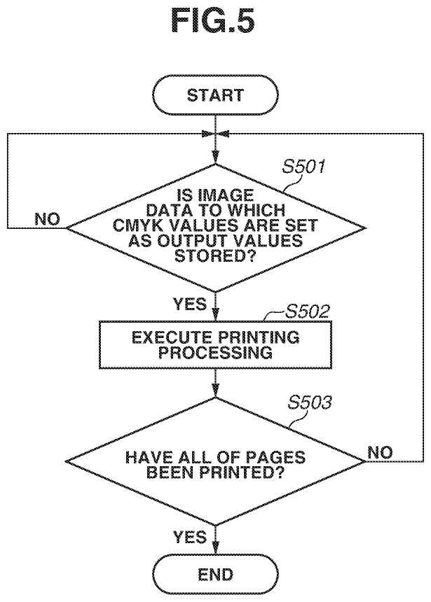

FIG. 5 is a flowchart illustrating an example of processing for printing an image on a sheet based on image data on which color space conversion is executed by the MFP 100. The CPU 101 reads out a program stored in the ROM 102 to the RAM 103 and executes the program, so that processing of the flowchart in FIG. 5 is implemented. The processing flow in FIG. 5 is started when the instruction for executing copying processing is received from the user in step S401 of FIG. 4.

In step S501, the CPU 101 determines whether image data to which the CMYK values are set as the output values is stored in the HDD 104. In other words, the CPU 101 determines whether the image data on which the color space conversion processing is executed in step S407 or S420 is stored. If the CPU 101 determines that the image data is stored (YES in step S501), the processing proceeds to step S502. If the CPU 101 determines that the image data is not stored (NO in step S501), the processing returns to step S501.

In step S502, the CPU 101 prints an image on a sheet based on the CMYK values of each of pixels calculated in step S407 or S420.

In step S503, the CPU 101 determines whether all of pages of a scanned document have been printed. If the CPU 101 determines that all of the pages of the scanned document have been printed (YES in step S503), the processing is ended. If the CPU 101 determines that not all of the pages of the scanned document have been printed (NO in step S503), the processing returns to step S501.

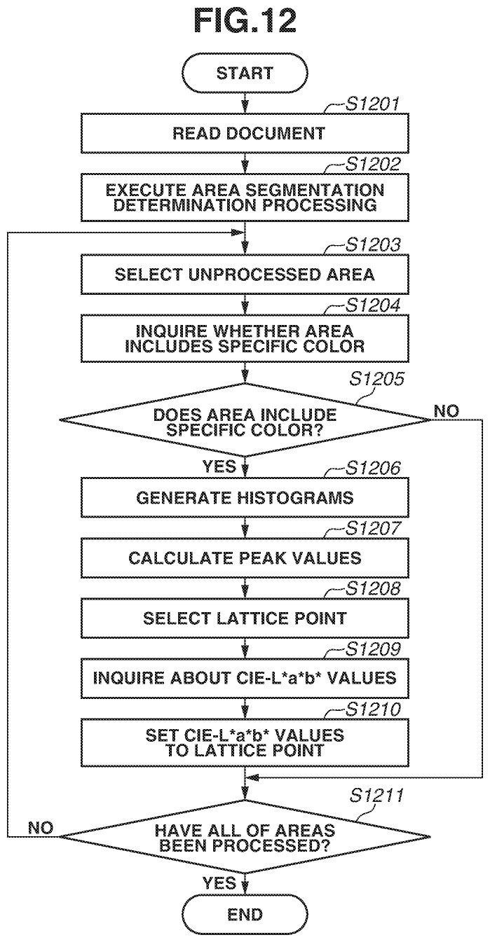

FIG. 12 is a flowchart illustrating an example of processing of setting the RGB values of the specific color to the MFP 100. The CPU 101 reads out a program stored in the ROM 102 to the RAM 103 and executes the program, so that processing of the flowchart in FIG. 12 is implemented. The processing flow in FIG. 12 is started when an instruction for executing setting processing of the specific color is received after the user has shifted the mode of the MFP 100 to a mode for setting the specific color.

In step S1201, the CPU 101 controls the scanner 106 to read an image of a document including the specific color set by the user and generates image data.

In step S1202, the CPU 101 executes processing similar to the processing executed in step S601.

In step S1203, the CPU 101 selects one of unprocessed areas from among the areas determined in step S1202.

In step S1204, the CPU 101 displays an image of the area selected in step S1203 cut into a rectangular shape on the operation unit 108, and receives information indicating whether the area includes the specific color by receiving input from the user. More specifically, the CPU 101 displays, on the operation unit 108, the image of the selected area cut into the rectangular shape and a button that enables the user to select whether the image includes the specific color. Then, the CPU 101 receives information indicating whether the area includes the specific color by the user selecting the corresponding button.

In step S1205, the CPU 101 determines whether the information received in step S1204 indicates that the area includes the specific color. If the information indicates that the area includes the specific color (YES in step S1205), the processing proceeds to step S1206. If the information indicates that the area does not include the specific color (NO in step S1205), the processing proceeds to step S1211.

In step S1206, the CPU 101 acquires pixel values (RGB values) of each pixel within the area, and generates histograms for the RGB colors through the processing similar to that of step S701.

In step S1207, the CPU 101 calculates peak values (most frequent values) of the histograms.

In step S1208, the CPU 101 selects a lattice point corresponding to the RGB values that are the closest to the most frequent values (RGB values) calculated in step S1207. The closest refers to a closest Euclidean distance in the RGB color space. The RGB values of the lattice point selected in step S1208 are stored as the RGB values of the specific color used for executing the specific color adjustment of the document.

In step S1209, the CPU 101 receives CIELab values to be associated with the lattice point selected in step S1208 from the user via the operation unit 108.

In step S1210, the CPU 101 associates the CIELab values received in step S1209 with the lattice point selected in step S1208.

In step S1211, the CPU 101 determines whether all of the segmented areas have been processed. If the CPU 101 determines that all of the areas have been processed (YES in step S1211), the processing is ended. If the CPU 101 determines that not all of the areas have been processed (NO in step S1211), the processing proceeds to step S1203. The lattice point information generated through the above-described processing may be saved and used as an ICC profile.

By executing the above-described processing, when a document using a specific color that falls outside the color gamut of the scanner 106 of the MFP 100 is to be copied, a color as close as possible to the color of the document can be output.

The first exemplary embodiment has been described with respect to the processing for outputting a color as close as possible to a specific color when a document including the specific color such as Chinese Red is to be copied. A second exemplary embodiment will be described with respect to processing for generating a portable document format (PDF) file for outputting a color as close as possible to the specific color when the document including the specific color such as Chinese Red is scanned and output. In the second exemplary embodiment, a configuration different from that of the first exemplary embodiment will be mainly described.

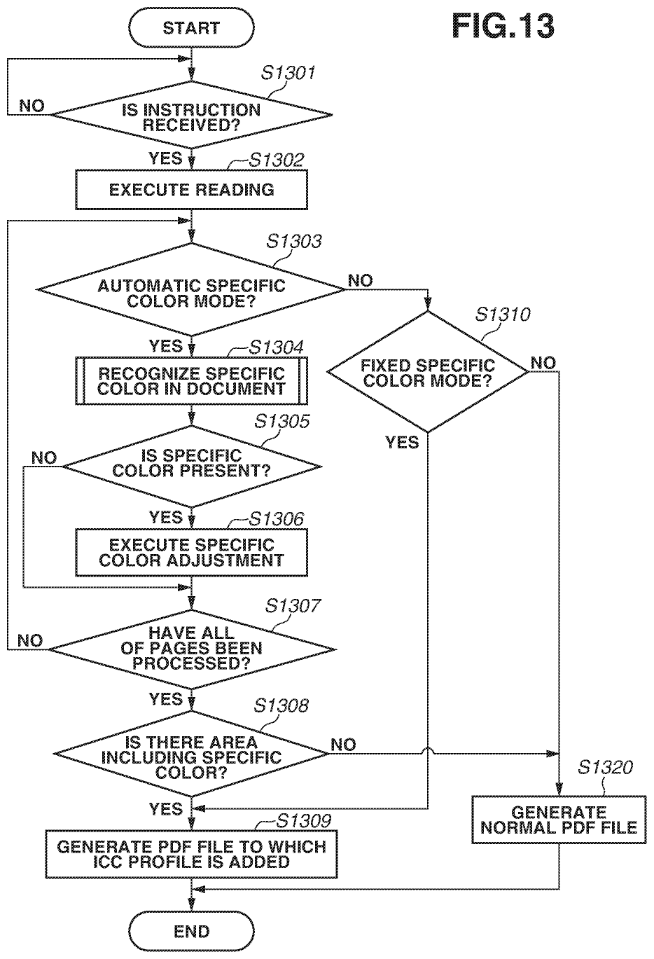

FIG. 13 is a flowchart illustrating an example of processing for scanning the document including the specific color and generating the PDF file. The CPU 101 reads out a program stored in the ROM 102 to the RAM 103 and executes the program, so that processing of the flowchart in FIG. 13 is implemented.

In step S1301, the CPU 101 determines whether a scanning instruction is received from the user via the operation unit 108. If the CPU 101 determines that the scanning instruction is received (YES in step S1301), the processing proceeds to step S1302. If the CPU 101 determines that the scanning instruction is not received (NO in step S1301), the processing returns to step S1301. In step S1301, the CPU 101 also receives an instruction about a scanning mode in addition to the scanning instruction. The instruction about the scanning mode is received on a screen illustrated in FIG. 11.

In step S1302, the CPU 101 reads an image on the document based on the instruction received from the user in step S1301, generates image data in RGB colors, and stores the image data in the HDD 104.

In step S1303, the CPU 101 determines whether the scanning mode is the automatic specific color mode. If the scanning mode is the automatic specific color mode (YES in step S1303), the processing proceeds to step S1304. If the scanning mode is not the automatic specific color mode (NO in step S1303), the processing proceeds to step S1310.

In step S1304, similar to the processing in step S404, the CPU 101 recognizes the specific color included in the generated image data.

In step S1305, the CPU 101 refers to a list stored in the RAM 103 in step S1304 and determines whether a flag indicating that the specific color is present in at least one area is stored. If the CPU 101 determines that the flag indicating presence of the specific color is stored (YES in step S1305), the processing proceeds to step S1306. If the CPU 101 determines that the flag indicating the presence of the specific color is not stored (NO in step S1305), the processing proceeds to step S1307.

In step S1306, similar to the processing in step S406, the CPU 101 executes specific color adjustment processing on the area in which the specific color is determined to be present.

In step S1307, the CPU 101 determines whether the specific color adjustment processing is executed on all of the scanned pages. If the CPU 101 determines that all of the scanned pages have been processed (YES in step S1307), the processing proceeds to step S1308. If the CPU 101 determines that not all of the scanned pages have been processed (NO in step S1307), the processing returns to step S1303.

In step S1308, with respect to all of the scanned pages, the CPU 101 determines whether there is at least one area including the specific color. If the CPU 101 determines that there is the area including the specific color (YES in step S1308), the processing proceeds to step S1309. If the CPU 101 determines that there is no area including the specific color (NO in step S1308), the processing proceeds to step S1320.

In step S1309, the CPU 101 generates a PDF file based on the generated image data. Further, the CPU 101 adds an ICC profile, which is a color conversion table for the specific color, to the generated PDF file whenever possible. Furthermore, in a case where the specific color falls within the color gamut of the printer 105, the CPU 101 adds, to the PDF file, the ICC profile obtained by converting the LUT (i.e., lattice) illustrated in FIG. 9C into an ICC profile format.

The information indicating the LUT (i.e., lattice) illustrated in FIG. 9A, 9B, 9C can be stored in the ICC profile. If the document is a Chinese official document with a red heading using Chinese Red, the ICC profile storing the information indicating the LUT (i.e., lattice) in FIG. 9B is added to the PDF file.

Herein, referring back to step S1303, processing to be executed when the CPU 101 determines that the mode is not the automatic specific color mode in step S1303 will be described.

In step S1310, the CPU 101 determines whether the scanning mode is the fixed specific color mode. If the CPU 101 determines that the scanning mode is the fixed specific color mode (YES in step S1310), the processing proceeds to step S1309. If the CPU 101 determines that the scanning mode is not the fixed specific color mode (NO in step S1310), the processing proceeds to step S1320.

In step S1320, the CPU 101 generates a normal PDF file based on the generated image data. The normal PDF file refers to a PDF file without the ICC profile added thereto or a PDF file with the ICC profile of a minimum color difference added thereto. In a case where the ICC profile is not added, the PDF file is printed using a setting of a printing device. In a case where the ICC profile of the minimum color difference is added, when printing the PDF file, an image true to the document image can be printed if its color falls within the color gamut printable by the device.

The PDF file generated in step S1309 or S1320 can be externally transmitted via the network OF 107 or can be stored in the HDD 104 or an external device. Further, the following processing is executed to print a PDF file to which the ICC profile indicating the specific color generated in step S1309 is added.

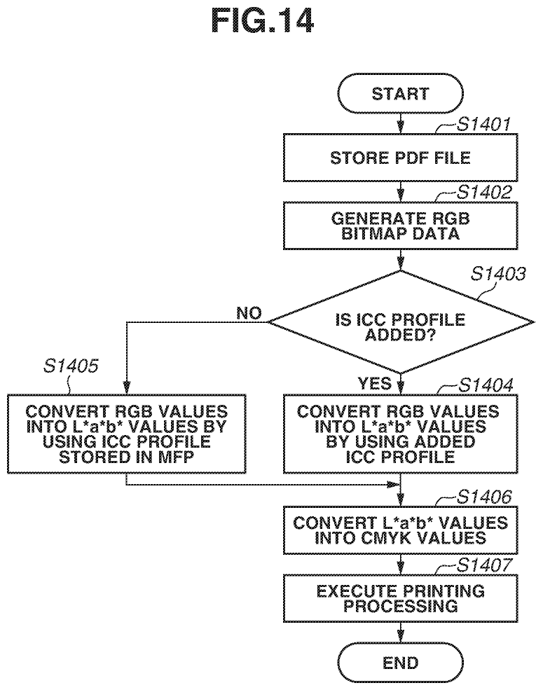

FIG. 14 is a flowchart illustrating an example of processing for printing the PDF file to which the ICC profile indicating the specific color is added. The CPU 101 reads out a program stored in the ROM 102 to the RAM 103 and executes the program, so that processing of the flowchart in FIG. 14 is implemented. The processing flow in FIG. 14 is started when a printing instruction of the PDF file is received from the user via the PC 200 or the operation unit 108.

In step S1401, the CPU 101 stores the PDF file in the RAM 103. Herein, the PDF file stored in the RAM 103 may be a PDF file transmitted from the PC 200 via the network I/F 107 or a PDF file stored in the HDD 104.

In step S1402, the CPU 101 analyzes the PDF file stored in the RAM 103 and generates RGB bitmap data.

In step S1403, the CPU 101 determines whether the ICC profile is added to the PDF file. If the CPU 101 determines that the ICC profile is added (YES in step S1403), the processing proceeds to step S1405. If the CPU 101 determines that the ICC profile is not added (NO in step S1403), the processing proceeds to step S1405.

In step S1404, the CPU 101 refers to the LUT included in the added ICC profile and converts RGB values of each pixel of the bitmap data into CIELab values.

In step S1405, the CPU 101 refers to the LUT included in the ICC profile stored in the ROM 102 of the MFP 100 and converts the RGB values of each of the pixels of the bitmap data into the CIELab values.

In step S1406, the CPU 101 converts the CIELab values of each of the pixels of the bitmap data into CMYK values.

In step S1407, the CPU 101 controls the printer 105 to print an image on a sheet based on the CMYK values converted in step S1406.

The file to which the ICC profile is added is not limited to the PDF file, and the file may also be a post script (PS) file.

Through the above-described processing, the PDF file that enables an output device to output a color as close as possible to a color of a document can be generated by reading the document in which a specific color falling outside a color gamut of a scanner of a MFP is used.

The units described throughout the present disclosure are exemplary and/or preferable modules for implementing processes described in the present disclosure. The term “unit”, as used herein, may generally refer to firmware, software, hardware, or other component, such as circuitry or the like, or any combination thereof, that is used to effectuate a purpose. The modules can be hardware units (such as circuitry, firmware, a field programmable gate array, a digital signal processor, an application specific integrated circuit, or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

### OTHER EMBODIMENTS

Embodiment(s) of the present disclosure can also be realized by a computerized configuration(s) of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computerized configuration(s) of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computerized configuration(s) may comprise one or more processors, one or more memories, circuitry, or a combination thereof (e.g., central processing unit (CPU), micro processing unit (MPU), or the like), and may include a network of separate computers or separate processors to read out and execute the computer executable instructions. The computer executable instructions may be provided to the computerized configuration(s), for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-163188, filed Aug. 31, 2018, which is hereby incorporated by reference herein in its entirety.

What is claimed is:

1. An image processing apparatus comprising:
a reading unit configured to read an image of a document to generate image data;
a conversion unit configured to convert a color value of a color, from among colors of the image data, falling within a color gamut of the reading unit into a first color value by using a first conversion table, and convert a color value of a specific color, from among the colors of the image data, falling outside the color gamut of the reading unit into a second color value without using the first conversion table; and
a printing unit configured to print an image on a sheet based on the color values converted by the conversion unit,
wherein a color of an image that is printed based on the second color value obtained by converting the color value of the specific color falling outside the color gamut without using the first conversion table is closer to the specific color falling outside the color gamut than a color of an image that is printed based on the first color value obtained by converting the color value of the specific color falling outside the color gamut by using the first conversion table.

2. The image processing apparatus according to claim 1, wherein the conversion unit converts the color value of the specific color, from among the colors of the image data, falling outside the color gamut of the reading unit into the second color value by using a second conversion table different from the first conversion table.

3. The image processing apparatus according to claim 2, wherein the first conversion table and the second conversion table are look-up tables.

4. The image processing apparatus according to claim 1, further comprising a setting unit configured to set a mode of the image processing apparatus,
wherein, in a case where a mode is set to a first mode by the setting unit, the conversion unit converts the color value of the specific color falling outside the color gamut to a third color value by using the first conversion table, and
wherein, in a case where a mode is set to a second mode by the setting unit, the conversion unit converts the color value of the specific color falling outside the color gamut to the second color value without using the first conversion table.

5. The image processing apparatus according to claim 4, further comprising a segmentation unit configured to segment image data generated by the reading unit into a plurality of areas,
wherein, in a case where a mode is set to the first mode by the setting unit, the conversion unit converts a color value of an area, from among the plurality of areas of the image data segmented by the segmentation unit, that includes the specific color falling outside the color gamut of the reading unit into the second color value without using the first conversion table, and converts a color value of an area, from among the plurality of areas of the image data segmented by the segmentation unit, that does not include the specific color falling outside the color gamut of the reading unit into the first color value by using the first conversion table.

6. The image processing apparatus according to claim 4, wherein the conversion unit converts a color value of an area, from among the plurality of areas of the image data segmented by the segmentation unit, that is a text area and includes the specific color falling outside the color gamut into the second color value without using the first conversion table, and converts a color value of an area, from among the plurality of areas of the image data segmented by the segmentation unit, that is a non-text area and includes the specific color falling outside the color gamut into the first color value by using the first conversion table.

7. The image processing apparatus according to claim 1, wherein the specific color falling outside the color gamut is Chinese Red.

8. An image processing apparatus comprising:
a reading unit configured to read an image of a document to generate image data;
a generation unit configured to generate a portable document format (PDF) file based on the image data generated by the reading unit; and
an addition unit configured to add a profile to the PDF file generated by the generation unit,
wherein, in a case where a specific color falling outside a color gamut of the reading unit is included in the image read by the reading unit, the addition unit adds the profile for outputting the specific color as a color closer to the specific color than a color output in a case where the profile is not added to the PDF file generated by the generation unit.

9. The image processing apparatus according to claim 8, further comprising a setting unit configured to set a mode of the image processing apparatus,
wherein, in a case where the mode is set to a first mode by the setting unit, the addition unit adds the profile to the PDF file in a case where the specific color falling outside the color gamut of the reading unit is included in the image read by the reading unit, and
wherein, in a case where the mode is set to a second mode by the setting unit, the addition unit does not add the profile to the PDF file in a case where the specific color falling outside the color gamut of the reading unit is included in the image read by the reading unit.

10. The image processing apparatus according to claim 9,
wherein, in a case where the mode is set to the first mode by the setting unit, the addition unit adds the profile to the PDF file in a case where the specific color falling outside the color gamut of the reading unit is included in the image read by the reading unit, and
wherein, in a case where the mode is set to the first mode by the setting unit, the addition unit does not add the profile to the PDF file in a case where the specific color falling outside the color gamut of the reading unit is not included in the image read by the reading unit.

11. The image processing apparatus according to claim 8, wherein the profile is a look-up table used for executing color space conversion.

12. The image processing apparatus according to claim 8, wherein the specific color falling outside the color gamut is Chinese Red.

13. A control method of an image processing apparatus including a reading unit configured to read an image of a document to generate image data, the control method comprising:
converting a color value of a color, from among colors of the image data, falling within a color gamut of the reading unit into a first color value by using a first conversion table, and converting a color value of a specific color, from among the colors of the image data, falling outside the color gamut of the reading unit into a second color value without using the first conversion table; and
printing an image on a sheet based on the converted color value,
wherein a color of an image that is printed based on the second color value obtained by converting the color value of the specific color falling outside the color gamut without using the first conversion table is closer to the specific color falling outside the color gamut than a color of an image that is printed based on the first color value obtained by converting the color value of the specific color falling outside the color gamut by using the first conversion table.

14. A control method of an image processing apparatus including a reading unit configured to read an image of a document to generate image data, the control method comprising:
generating a portable document file (PDF) file based on the image data generated by the reading unit; and
adding a profile to the generated PDF file,
wherein, in a case where a specific color falling outside a color gamut of the reading unit is included in the image read by the reading unit, in the adding, the profile for outputting the specific color as a color closer to the specific color than a color output in a case where the profile is not added to the generated PDF file is added.

15. A non-transitory computer-readable storage medium storing a program that, when executed by a computer, causes the computer to perform a method of controlling an image processing apparatus including a reading unit configured to read an image of a document to generate image data, the method comprising:
converting a color value of a color, from among colors of the image data, falling within a color gamut of the reading unit into a first color value by using a first conversion table, and converting a color value of a specific color, from among the colors of the image data, falling outside the color gamut of the reading unit into a second color value without using the first conversion table; and
printing an image on a sheet based on the converted color value,
wherein a color of an image that is printed based on the second color value obtained by converting the color value of the specific color falling outside the color gamut without using the first conversion table is closer to the specific color falling outside the color gamut than a color of an image that is printed based on the first color value obtained by converting the color value of the specific color falling outside the color gamut by using the first conversion table.

16. A non-transitory computer-readable storage medium storing a program that, when executed by a computer, causes the computer to perform a method of controlling an image processing apparatus including a reading unit configured to read an image of a document to generate image data, the method comprising:
generating a portable document file (PDF) file based on the image data generated by the reading unit; and
adding a profile to the generated PDF file,
wherein, in a case where a specific color falling outside a color gamut of the reading unit is included in the image read by the reading unit, in the adding, the profile for outputting the specific color as a color closer to the specific color than a color output in a case where the profile is not added to the generated PDF file is added.
